(19) United States
(12) Patent Application Publication
(10) Pub. No.: US 2007/0082689 A1
(43) Pub. Date: Apr. 12, 2007

(54) Alert notification network

(76) Inventors: Timothy J. Talty, Beverly Hills, MI (US); Andrew J. MacDonald, Grosse Pointe Park, MI (US); Varsha Sadekar, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/244,761

(22) Filed: Oct. 6, 2005

(51) Int. Cl. H04Q 7/38; H04B 7/00

(52) U.S. Cl. 455/518; 455/414.1

(57) ABSTRACT

A network server is presented operable to communicate time-critical information over a wireless communications system, comprising a location manager, an alert notification manager, and a message delivery notification manager. The communications system is a push-to-talk over cellular system, including a wireless carrier core IP network, which may connected to a private intranet service. Location manager identifies and locates recipients within a known geographical area. Message delivery notification manager schedules and formats delivery of alert messages, based upon geographic location and direction of travel of each recipient. The network utilizes existing systems to communicate the information utilizing a push-to-talk cellular networking system, to immediately provide such information to the subscriber without inquiry seeking such information.

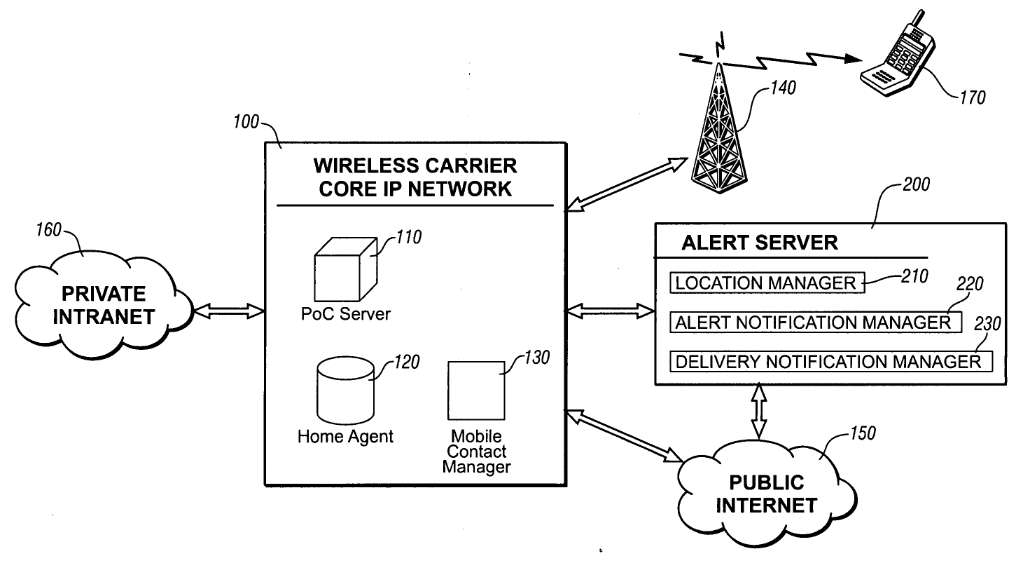

### TECHNICAL FIELD

This invention pertains generally to telematics systems, and more particularly to a method and system to communicate time-critical alerts over a telematics system.

### BACKGROUND OF THE INVENTION

Wireless communication system technologies are rapidly evolving. In a wireless communication system, radiofrequency channels are used to communicate data. Many radio communication systems utilize digital communication techniques in which data is communicated through radio communication channels in digital form. A cellular communication system is one example of such communication systems.

Wireless communications systems suppliers currently provide push-to-talk operation. In this operation of the mobile station, simplex communication of voice data is provided. The push-to-talk capability has attained a level of popularity as nearly-instantaneous voice communications are commenced upon start of the push-to-talk operation of the mobile station.

Conventional cellular communications, generally, do not provide for push-to-talk capability. Rather, call set-up procedures are carried out in a conventional cellular communication system when a call is initiated by a user, and the calling procedures must be successfully completed before voice communications commence. Immediate voice communications are thus unavailable in a conventional cellular communication system, i.e. there is a delay, or latency, in the communications. Additionally, an intended receiver of a call must accept an incoming call for communications to commence.

Mobile communication units, such as cellular phones, personal data assistants, Global Positioning System devices, and on-board vehicle communication units used in conjunction with a Wide Area Network, such as a cellular telephone network or a satellite communication system, have made it possible for a person to send and receive voice communications, data transmissions, and fax messages from virtually any location. Such communication is initiated at the device when it is turned on, or by entering a phone number to be called, or in many cases, by pressing a preprogrammed button on the device or speaking a voice command causing the device to automatically complete the process of dialing the number to be called. A radio communication link is established between the device and a Wide Area Network (WAN), using a node of the WAN in the vicinity of the device.

Push-to-talk-over-cellular (‘PoC’) telephonic service is being developed to provide push-to-talk capability on cellular communications systems. PoC service is a half-duplex form of communications that allows users to engage in immediate communication with one or more receivers, similar to walkie-talkie type operation, simply by pushing a button on their handsets. PoC is an extremely efficient way for network operators to provide an affordable new service to cost-conscious end users while placing a minimum strain on resources. Less bandwidth is required for a PoC call than a regular voice call. In a circuit-switched call, the network capacity is used for the duration of the call, from connection attempt to hang-up. In a PoC call, only the actual blocks of talk that comprise the conversation result in load being placed on the network. This lower resource requirement makes PoC attractive and cost-effective to implement over an existing network. PoC offers the end user a flexible communication option and the convenience of an always-on, virtually instant connection to individuals or groups.

Public Internet and private intranet systems currently gather substantial amounts of information useful to persons having personal wireless communications devices, including those devices implemented in vehicles. Such information may be used by persons to inform their decisions about how and where to proceed. However, access to such information may be difficult to obtain in a timely manner to allow the information to be beneficial to the person.

Therefore, a system that is able to identify and collect time-critical information in a known geographic area is desirable. A telematics communication system and network which is able to provide the time-critical information to persons, e.g., subscribers to a system, in a timely manner relative to when the person comes near or into the presence of a time-critical situation, is desirable. The telematics communication system and network utilizing existing systems to communicate the time-critical information utilizing a push-to-talk cellular networking system is desirable, as is immediately providing such information to the subscriber without the person's inquiry seeking such information.

### SUMMARY OF THE INVENTION

In accordance with the present invention, a network server is presented that is operable to communicate time-critical information over a wireless communications system, comprising a location manager, an alert notification manager, and a message delivery notification manager.

Another aspect of the invention comprises the wireless communications system being a push-to-talk over cellular system, wherein the wireless communications system further includes a wireless carrier core IP network.

Another aspect of the invention comprises the wireless carrier core IP network operably connected to a private intranet service.

Another aspect of the invention comprises the location manager operable to identify and locate a plurality of recipients within a known geographical area.

Another aspect of the invention comprises the message delivery notification manager operable to schedule and format delivery of alert messages to a plurality of recipients, based upon a geographic location of each recipient and a direction of travel of each recipient.

Another aspect of the invention comprises each message recipient being a vehicle having an on-board communications system.

Another aspect of the invention includes the recipient being an individual having a communications device with a global positioning system transponder or other method of determining recipient position and heading.

Another aspect of the invention comprises the alert notification manager operable to receive and aggregate alert messages, and prepare the aggregated alert messages for delivery.

Another aspect of the invention comprises the network server operable to collect time-critical information, wherein the network server is operable to identify available time-critical services compatible with network latencies; and, collect appropriate time-critical messages consistent with the identified time-critical services. This includes time-critical services compatible with network latencies of approximately one second.

Another aspect of the invention comprises a method for communicating time-critical information to a plurality of recipients with a push-to-talk over cellular wireless communications system.

These and other aspects of the invention will become apparent to those skilled in the art upon reading and understanding the following detailed description of the embodiments.

### BRIEF DESCRIPTION OF THE DRAWING

The invention may take physical form in certain parts and arrangement of parts, the preferred embodiment of which will be described in detail and illustrated in the accompanying drawing which forms a part hereof, and wherein:

The figure is a system schematic, in accordance with the present invention.

### DETAILED DESCRIPTION OF THE PREFERRED EMBODIMENT

Referring now to the drawing, wherein the showings are for the purpose of illustrating the invention only and not for the purpose of limiting the same, a schematic diagram of a system for notifying a subscriber of time-critical events is shown, in accordance with an embodiment of the current invention. The exemplary system for notifying a plurality of subscribers comprises: a wireless carrier core IP network 100, one or more wireless carrier systems 140, a telematics unit 170, and alert server 200.

Telematics unit 170 may be fixedly installed into a motor vehicle, such as an automobile or truck, or other vehicles. Alternatively, the telematics unit may comprise a hand-held device carried by an individual. The telematics unit 170 is preferably equipped with suitable hardware and software for transmitting and receiving voice and data communications. Elements of the telematics unit 170 preferably comprise: a digital signal processor connected to a wireless modem; a global positioning system (‘GPS’) receiver or GPS unit; an electronic memory; a microphone; one or more audio speakers; an embedded telephone or an email access appliance; a real time clock; a display; and a software monitor for reading a time signal of real time clock. The GPS unit provides longitude and latitude coordinates of the device, as well as a time stamp and a date stamp. The telephone preferably comprises a cellular communications device having push-to-talk-over-cellular (‘PoC’) capability, and is operable to send and receive over-the-air messages, including those originating from the alert server 200.

The telematics unit 170 sends and receives radio transmissions from wireless carrier core IP network 100 via the one or more wireless carrier systems 140 which are operable to communicate using cellular systems.

Wireless carrier core IP network 100 includes a PoC server 110, a home agent 120, and mobile contact manager 130, which work in conjunction with the alert server 200, to deliver timely and geographic position-appropriate messages to telematics unit 170. The home agent 120 and mobile contact manager 130 are preferably operable to track and manage information about each subscriber, based upon communications through the wireless carrier systems 140.

Wireless carrier core IP network 100 preferably includes services from mobile telephone switching offices, wireless networks, public-switched telephone networks, and Internet protocol (‘IP’) networks. Network 100 comprises a wired network, an optical network, a fiber network, another wireless network, or any combination thereof, and connects to telematics unit 170 via wireless carrier system 140. Wireless carrier core IP network 100 is operable to communicate with various public Internet servers 150 to obtain localized location-specific time-critical information, such as traffic reports, road construction updates. Wireless carrier core IP network 100 is operable to communicate with private intranet servers 160 to obtain similar information of interest.

Wireless carrier core IP network 100 sends and receives messages according to established protocols for cellular phone communications such as IS-637 standards for short message service (SMS), IS-136 air-interface standards for SMS, and GSM 03.40 and 09.02 standards.

The alert server 200 may be incorporated as an element of a call center. The call center comprises a virtual location wherein many calls are received and serviced at the same time, or wherein many calls are sent at the same time. In one embodiment of the invention, the call center is a telematics call center, prescribing communications to and from telematics unit 170. In another embodiment, the call center is a voice call center, providing verbal communications between a communication services advisor in the call center and one or more subscribers. In another embodiment, the call center contains each of these functions. In another embodiment, the call center serves as a fully automated center providing telematics service center data, including execution of the functions of the alert server 200.

Communication services advisor may be a real advisor or a virtual advisor. A real advisor is a human being in verbal communication with a user or subscriber. A virtual advisor is a synthesized voice interface responding to requests from user or subscriber. In one embodiment, virtual advisor includes one or more recorded messages. In another embodiment, virtual advisor generates voice messages using a text to speech synthesis engine (TTS). In another embodiment virtual advisor includes both recorded and TTS generated messages.

The system presented includes the alert server 200 operable to collect, aggregate, and communicate time-critical information over the wireless carrier core IP network 100. The alert server comprises a location manager 210, an alert notification manager 220, and a message delivery notification manager 230. The wireless communications system preferably comprises the PoC communications system, as previously discussed. The location manager 210 is operable to identify and locate telematics units within a known geographical area. The term ‘recipient’ as used herein describes a telematics unit receiving the time-critical information. The time-critical information is communicated to the recipient via communications system described herein.

The message delivery notification manager 230 is operable to schedule and format delivery of alert messages to the recipients, consistent with the specific communications system and telematics hardware and operating system. The message delivery notification manager 230 schedules and formats delivery of various time-critical alert messages to each recipient, based upon location and direction of travel of each of the recipients.

The alert notification manager 220 receives and aggregates alert messages, including a geographic location of the source of the alert, and prepares the aggregated alert messages for delivery. The alert server 200 works with the alert notification manager 220 to collect time-critical information from various sources which is formed into the alert messages. Collecting time-critical information includes identifying available services compatible with network latencies; and, collecting appropriate time-critical messages consistent with the identified services. Exemplary vehicle time-critical information that may be compiled, aggregated and communicated to subscribers in alert messages may include, for example, warning of approaching emergency vehicles; warnings of approaching sharp curves, low or narrow bridges, or other non-obvious road features; warnings of road surface changes due to ambient conditions, e.g. fog, ice, drifting snow, water, flooding; warnings of approaching rail trains for collision avoidance; Amber alert details; warnings of approaching work zones; and, warnings of approaching traffic congestion or changed traffic patterns, and warning of vehicle approach to a school zone wherein speed limits are restricted at specific times of the day. Other specific information may be developed and implemented according to needs of an individual network, consistent with the communications ability of the network system and the vehicles. Other specific services compatible with network latencies currently comprise services able to accept a latency of approximately one second, due to current delay times of the PoC cellular system. It is envisioned that additional alert messages may become appropriate for communication to subscribers when delay times of the PoC cellular system decrease with the advent of new technology.

In operation, the alert server 200 acts to push communications of alert messages to each subscriber, based upon each recipient's location and direction of travel relative to location of each known time-critical event or location. Each recipient's location and direction of travel can be determinable using information from the GPS transponder. The alert messages are preferably pushed to each subscriber through the subscriber's telematics device 170, and may take the form of a voice message heard audibly by the subscriber, or in the form of a written message printed on a visual display such as a vehicle information center, or in the form of an audible alert coupled with a written message, or in the form of a bank of lamps viewable by the subscriber, which are associated with various alert messages.

The alert server 200 collects and receives time-critical information from a variety of sources, including information available on the Internet 150, and information developed on the server's private intranet 160. The information developed on the server's private intranet 160 may comprise electronically available information, or information collected or captured and interpreted by a human operator who is able to encode the information in a manner suitable for use by the server.

The subscriber may desire regular notification of specific events or kinds of events. One example of event notification is traffic conditions. In this case, the network may regularly capture traffic events from public and private sources that are relevant to the subscriber's geographic location and direction of travel, and provide such information on a scheduled basis, including a notification that there are no incidences for which the subscriber has cause for concern.

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. Network server operable to communicate information over a wireless communications system, comprising: a location manager; an alert notification manager; and a message delivery notification manager.

2. The network server of claim 1, wherein the wireless communications system comprises a push-to-talk over cellular system.

3. The network server of claim 2, wherein the wireless communications system further includes a wireless carrier core IP network.

4. The network server of claim 3, wherein the wireless carrier core IP network is operably connected to a private intranet service.

5. The network server of claim 3, wherein the wireless carrier core IP network is operably connected to a public internet service.

6. The network server of claim 1, wherein the location manager is operable to identify and locate a plurality of recipients within a known geographical area.

7. The network server of claim 6, wherein each recipient comprises an on-board vehicular telematics unit.

8. The network server of claim 1, wherein the message delivery notification manager is operable to schedule and format delivery of alert messages to a plurality of recipients.

9. The network server of claim 8, wherein the delivery of alert messages to recipients is based upon a geographic location of each recipient.

10. The network server of claim 9, wherein the delivery of alert messages to recipients is based upon a direction of travel of each recipient.

11. The network server of claim 1, wherein the alert notification manager is operable to receive and aggregate alert messages.

12. The network server of claim 11, wherein the alert notification manager is further operable to prepare the aggregated alert messages for delivery.

13. The network server of claim 1, wherein the network server is operable to:
identify available services compatible with network latencies; and,
collect appropriate alert messages consistent with the identified services.

14. The network server of claim 13, wherein services compatible with network latencies comprise services able to accept a latency of approximately one second.

15. Wireless network server adapted to collect, aggregate, and communicate vehicle related information to a plurality of vehicular telemematics units, comprising:
a vehicle location manager;
an alert notification manager; and,
a message delivery notification manager.

16. The wireless network server of claim 15, wherein the vehicle location manager is operable to identify a geographic location of each vehicular telematics unit.

17. The wireless network server of claim 16, wherein the alert notification manager is operable to receive and aggregate alert messages.

18. The wireless network server of claim 17, wherein the alert notification manager is further operable to prepare the aggregated alert messages for delivery.

19. The wireless network server of claim 18, wherein the message delivery notification manager is operable to schedule and format delivery of alert messages to each of the plurality of vehicular telematics units based upon the geographic location of each vehicular telematics units.

20. Method for communicating information through a push-to-talk over cellular wireless communications system, comprising: interfacing a network server with a wireless carrier core IP network, the network server operable to:
identify and locate push-to-talk telematics units within a geographic area;
receive alert messages;
aggregate the alert messages;
prepare the alert messages for delivery; and,
schedule and format the alert messages for delivery, based upon the geographic location of each push-to-talk telematics units.

21. The method of claim 20, wherein the network server is operable to:
determine direction of travel of each push-to-talk telematics unit; and,
schedule and format the alert messages for delivery, based upon the direction of travel of each push-to-talk telematics unit.
